(19) United States
(12) Patent Application Publication
(10) Pub. No.: US 2022/0205323 A1
(43) Pub. Date: Jun. 30, 2022

(54) UTILITY LADDER

(71) Applicant: Charles Isgar, Scottsdale, AZ (US)

(72) Inventor: Charles Isgar, Scottsdale, AZ (US)

(21) Appl. No.: 17/698,770

(22) Filed: Mar. 18, 2022

Related U.S. Application Data
(62) Division of application No. 16/007,822, filed on Jun. 13, 2018.
(60) Provisional application No. 62/588,032, filed on Nov. 17, 2017.

(51) Int. Cl. E06C 7/14; E06C 7/00; E06C 1/18

(52) U.S. Cl. CPC E06C 7/14; E06C 1/18; E06C 7/00

(57) ABSTRACT

A ladder and tool kit combination is described. The ladder and tool kit combination uses a tool kit concealed underneath the ladder. The ladder can open and close with the tool kit still attached. The tool kit may have an opening for electronic media from which the user may receive audio and/or video repair instructions while the ladder is in use.

### CROSS REFERENCE TO RELATED APPLICATION[S]

This application is a divisional of U.S. patent application entitled “UTILITY LADDER,” Ser. No. 16/007,822, filed Jun. 13, 2018, which claims priority to U.S. Provisional Patent Application entitled “UTILITY LADDER,” Ser. No. 62/588,032, filed Nov. 17, 2017, now pending, the disclosures of which are hereby incorporated entirely herein by reference.

### BACKGROUND OF THE INVENTION

### Technical Field

This invention relates to a ladder and tool kit combination and method of using a ladder and tool kit in a space saving utility incorporation.

### State of the Art

Ladders and tool kits often are used in conjunction with each other. Often small ladders or step ladders have holders for tools when the ladder is in use, but nowhere to store the tools when the ladder is closed. Saving space is especially important in smaller spaces, such as in utility closets and small apartments.

Accordingly, a ladder and tool kit combination is needed to hold tools and such and easily accessible when using the ladder or using the tools without the ladder.

### DISCLOSURE OF THE INVENTION

Disclosed is a ladder and tool kit combination comprising: the ladder having at least one climbing rung; a front ladder section; a rear ladder section; and a top rung, wherein the front ladder section is pivotably connected to the rear ladder section via the top rung; and the tool kit having a tool kit main body storing tools within the tool kit main body, the tool kit moveable between a stowed position and useable position.

The ladder and tool kit may be one piece. The tool kit may be operational when the ladder is in a closed position. The tool kit may be operational when the ladder is in the open position. The tool kit may be a rigid tool box, a tool pouch or the like. The ladder may have an opening to access audio and/or video electronic media, especially home repair instructions while using the ladder. The tool kit main body may be interconnected with the ladder front section. The tool kit main body may be interconnected with the ladder rear section. The tool kit main body may be interconnected with both the ladder front section and the ladder rear section.

Disclosed is a method of using a ladder and tool kit combination comprising: moving the tool kit from a stowed position to a useable position, wherein the tool kit is located under a top rung of the ladder in the stowed position and moved out from under the top rung of the ladder when in the useable position; accessing tools stored within a tool kit main body of the tool kit; placing the tools within the tool kit main body after use of the tools; and moving the tool kit from the useable position to the stowed position, wherein moving the tool kit between the stowed position and the useable position can occur with the ladder is a folded or unfolded position. Further, the tool kit main body may be removed from the ladder when the ladder is in the closed or open position and used in a location remote from the ladder and then returned and coupled to the ladder when done.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 is a perspective view of a ladder and tool kit combination with the ladder in the open position according to an embodiment;

FIG. 2 is another perspective view of a ladder and tool kit combination with the ladder in the open position according to an embodiment;

FIG. 3 is a side view of another embodiment of a ladder and tool kit combination with the ladder in the open position according to an embodiment;

FIG. 4 is a perspective view of another embodiment of a ladder and tool kit combination with the ladder in the closed position according to an embodiment;

FIG. 5 is a perspective view of a ladder and tool kit combination with the with the tool kit as a top rung of the ladder according to an embodiment; and

FIG. 6 is a perspective view of a ladder and tool kit combination with the with the tool kit as a top rung of the ladder with the tool kit open according to an embodiment.

### DETAILED DESCRIPTION OF EMBODIMENTS OF THE INVENTION

The ladder and tool kit combination as described herein combines a step ladder and tool kit into one functional unit. The ladder and tool kit combination is useful for small spaces, such as apartments. Tools from the tool box are accessible to a user while positioned and/or off the ladder. The tool kit may be built into the ladder top shelf.

The tool kit is functional in both the open position and the closed position of the ladder, wherein the tools are accessible when the ladder is in the closed or open position. The tool kit and ladder combination may be manufactured as one piece. In the alternative, the tool kit may be attached to the ladder after manufacture. The tool kit and ladder combination allows all ladder functions, including opening or erecting, closing and/or storing, without disrupting the tool kit.

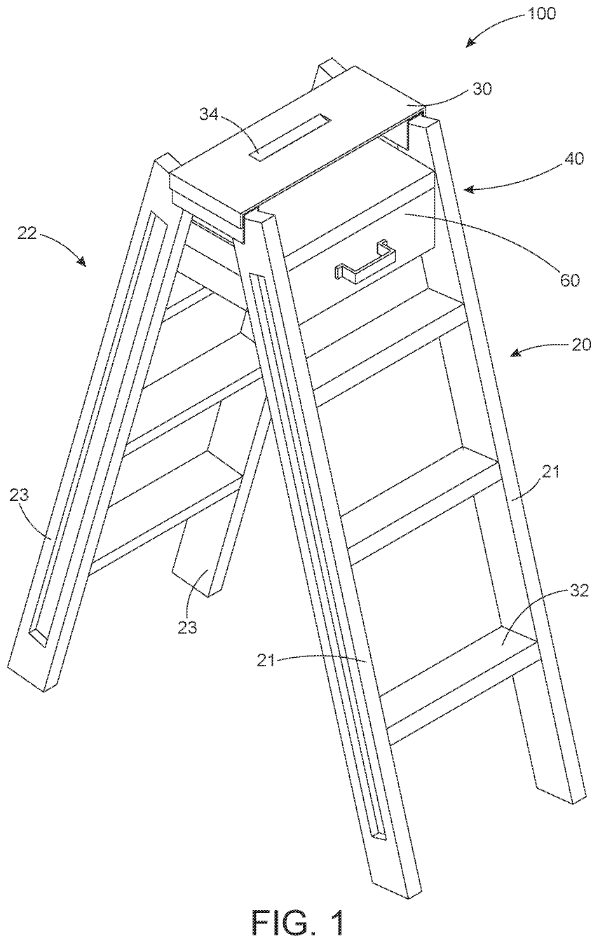

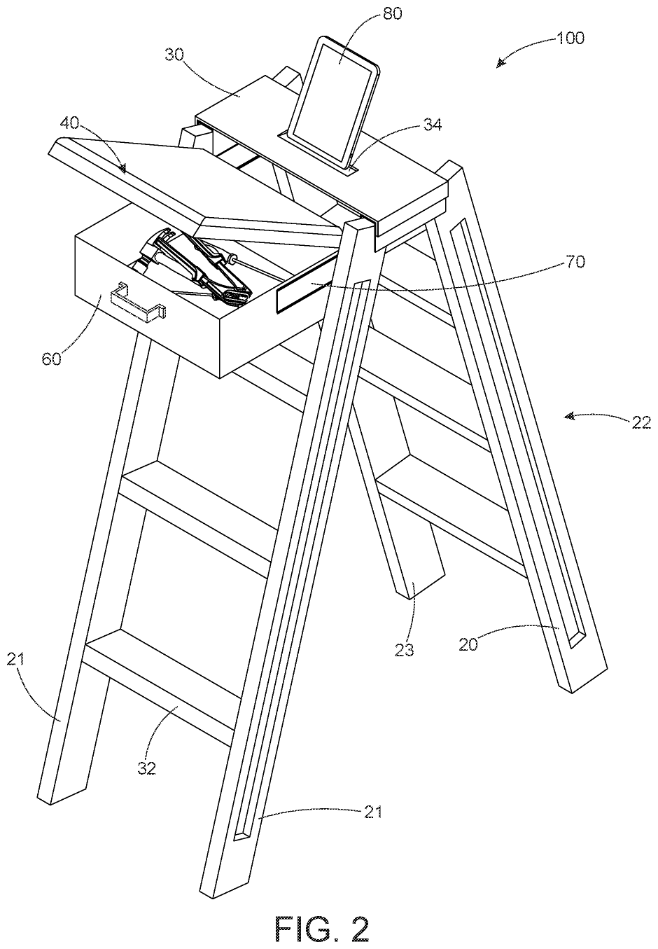

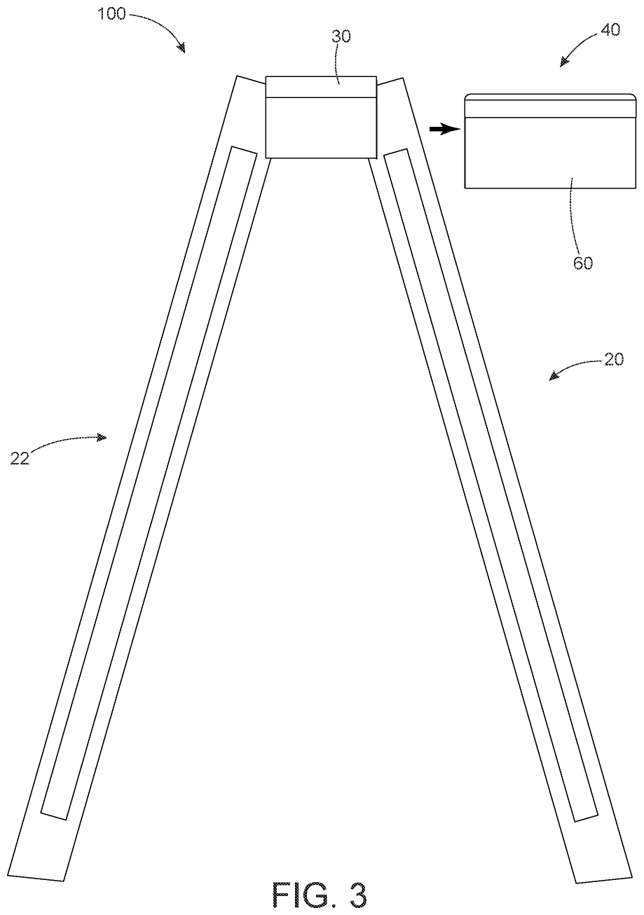

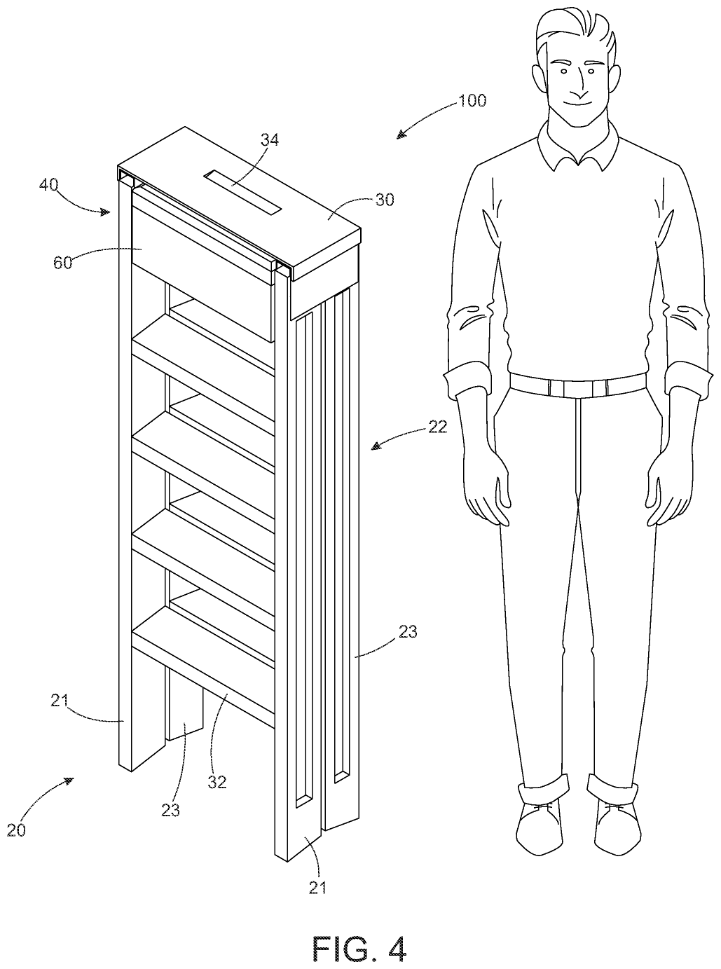

FIGS. 1-4 shows step ladder 100 having steps or climbing rungs 10. Step ladder 100 comprises a pair of pivotably connected ladder sections, front ladder section 20 and rear ladder section 22. Front ladder section 20 is pivotably connected via a top rung 30 to rear ladder section 22. Tool kit 40 is moveably coupled to the ladder 100 and may be positioned between the pair of ladder sections 20, 22 near the apex or top portion of each ladder section 20, 22. Tool kit 40 in some embodiments may be located below top rung 30 and above the rung below top rung 30. In other embodiments, the tool kit 40 may be located in other locations of the ladder. Front ladder section 20 may include front legs 21 with step rungs 32 coupled between the front legs 21. The rear ladder section 22 may also include legs 23. The tool kit 40 situated in a stowed position when the ladder is in a closed position does not extend beyond the dimensions of the ladder with the tool kit located between the top rung and the next adjacent lower rung. It will be understood that the tool kit may be located in other positions of the ladder.

The tool kit 40 may include a tool kit main body 60 that is moveably coupled to ladder 100 with a sliding bracket 70 that is interconnected with the ladder 100. The interconnection enables tool kit 40 to be moved between a stowed position and a useable position by allowing the tool kit 40 to slide out from under the top rung 30 into a useable position to provide access to the tools within the tool kit 40 and then slid under the top rung in the stowed position located between the top rung and the next adjacent lower rung. While it is depicted that the tool kit 40 is slideably coupled to the ladder 10, other embodiments may include other ways of moving the tool kit 40 between the stowed and useable positions. For example and without limitation, the tool kit 40 may be coupled to the ladder with a pivot arm system, with a hinge system or the like.

Additionally, in operation, the tool kit 40 may be removed from the ladder 100 and access tools 62 from within the tool kit main body 60. The handle of the tool kit main body 60 may be used to remove the tool kit main body 60 from the ladder 100. This allows the ladder with the tool kit to be utilized in areas where space saving is critical, such as in apartments and the like, wherein the ladder and the tool kit combination may be stored behind a door, in a laundry room, within a storage closet, and the like.

Tool kit 40 may be constructed of many different materials. Tool kit 40, for example, may be in the form of a rigid tool box, a collapsible tool pouch or the like. Top rung 30 may further comprise an opening or slot 34 for holding a mobile computing device 80 to provide easy access to a mobile computing device for audio and/or video repair instructions via electronic media while a user is on the ladder performing the repair. The ladder 100 may also include a power port (not shown) with a cord that extends to the tool kit 40. The port may be plugged into a power supply and the cord extends to the tool kit to allow for charging of batteries for power tools, to power a power tool directly, to power a work light mounted to a top rung 30 of the ladder 10 and the like.

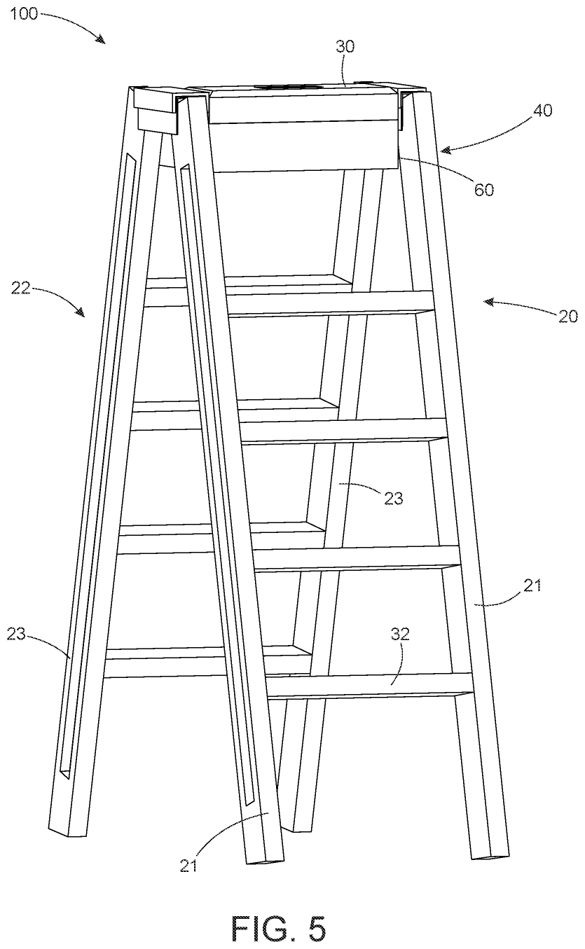

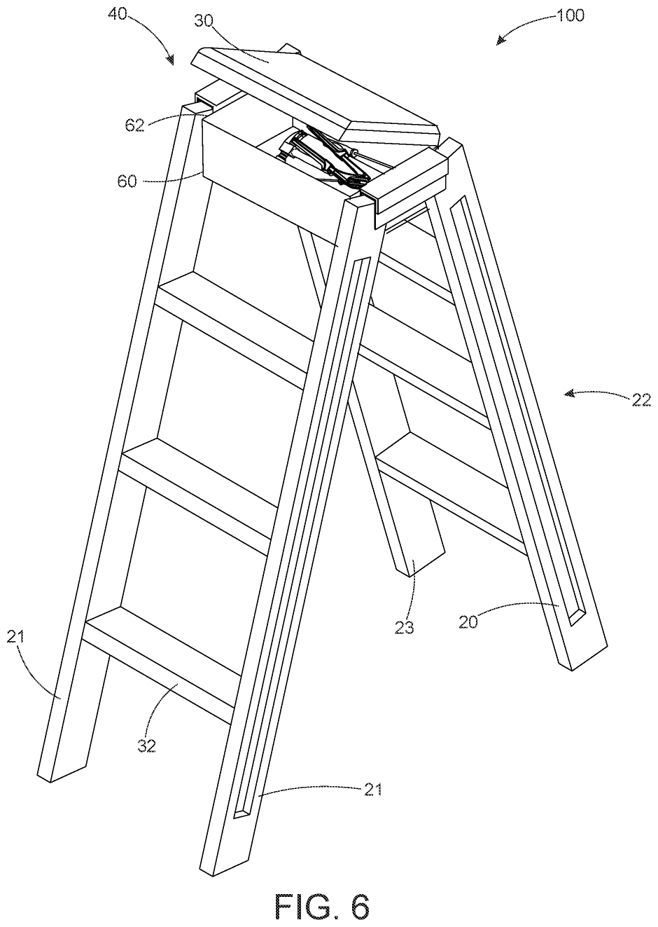

In an additional embodiment, as shown in FIGS. 5-6, the tool kit 40 may operate as the top rung 30 of the ladder 10. The lid of the tool kit 40 operates as the top surface of the top rung 30, with access to tools occurring when the lid is opened. In these embodiments, the tool kit 40 is not removable from the ladder 10. In operation, the tool kit 40 may be accessed at any time from the ladder 10, wherein the user can open the tool kit 40 and utilize tools 62. It is even easier to access tools 62 from within the tool kit 40 when the ladder 10 is in use. A user can easily open the lid of the tool kit while standing on rungs 32 of the ladder 10 in order to select, use and return the needed tool to the tool kit 40. Once use of the tools is completed, the ladder 10 may be folded up and easily stored with the tool kit 40 as an integral non-removable component of the ladder 10.

The method of using the ladder and tool kit combination may include moving the tool kit from a stowed position to a useable position, wherein the tool kit is located under a top rung of the ladder in the stowed position and moved out from under the top rung of the ladder when in the useable position; accessing tools stored within a tool kit main body of the tool kit; placing the tools within the tool kit main body after use of the tools; and moving the tool kit from the useable position to the stowed position, wherein moving the tool kit between the stowed position and the useable position can occur with the ladder is a folded or unfolded position.

The method may further include removably coupling a mobile computing device to a slot in the top rung of the ladder; and accessing the mobile computing device for audio and/or video of instructions. Further still, the method may include connecting a power port to a power supply with a cable extending through a leg of the ladder; and plugging a powered device into the power port of the ladder.

Embodiments may be available on or through the internet, such as through domain names reserved and owned by Applicant that include allinoneladder.com, myeasyladder.com, or the like.

The components defining any utility ladder with a tool kit may be formed of any of many different types of materials or combinations thereof that can readily be formed into shaped objects provided that the components selected are consistent with the intended operation of a utility ladder with a tool kit. For example, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining any utility ladder with a tool kit may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

What is claimed is:

1. A ladder and tool kit combination comprising:
the ladder having at least one climbing rung;
a front ladder section;
a rear ladder section; and
a top rung formed of a tool kit, wherein the front ladder section is pivotably connected to the rear ladder section via the tool kit top rung, wherein the tool kit includes a tool kit main body storing tools within the tool kit main body.

2. The ladder and tool kit combination of claim 1, wherein the tool kit is integral with and non-removable from the ladder.

3. A method of using a ladder and tool kit combination comprising:
moving the tool kit from a stowed position to a useable position, wherein the tool kit is located under a top rung of the ladder in the stowed position and moved out from under the top rung of the ladder when in the useable position;
accessing tools stored within a tool kit main body of the tool kit;
placing the tools within the tool kit main body after use of the tools; and
moving the tool kit from the useable position to the stowed position.

4. The method of claim 3, wherein the tool kit is coupled to the ladder with hooks.

5. The method of claim 3, wherein the tool kit is coupled to the ladder with a sliding bracket.

6. The method of claim 3, further comprising removably coupling a mobile computing device to a slot in the top rung of the ladder.

7. The method of claim 6, further comprising accessing the mobile computing device for audio and/or video of instructions.

8. The method of claim 3, further comprising connecting a power port to a power supply with a cable extending through a leg of the ladder.

9. The method of claim 8, further comprising plugging a powered device into the power port of the ladder.
